(19) United States
(12) Patent Application Publication
(10) Pub. No.: US 2025/0146103 A1
(43) Pub. Date: May 8, 2025

(54) Method for recovering iron and aluminum from red mud

(71) Applicant: ZHENGZHOU NON-FERROUS METALS RESEARCH INSTITUTE CO.LTD OF CHALCO, Zhengzhou (CN)

(72) Inventors: Lijuan QI, Zhengzhou (CN); Jie ZHENG, Zhengzhou (CN); Shuai SHAO, Zhengzhou (CN); Qing YU, Zhengzhou (CN); Chunhui ZHENG, Zhengzhou (CN)

(73) Assignee: ZHENGZHOU NON-FERROUS METALS RESEARCH INSTITUTE CO.LTD OF CHALCO, Zhengzhou (CN)

(21) Appl. No.: 19/011,850

(22) Filed: Jan. 7, 2025

Related U.S. Application Data
(63) Continuation of application No. PCT/CN2023/105268, filed on Jun. 30, 2023.

(30) Foreign Application Priority Data
Jan. 30, 2023 (CN) 202310045882.2

(51) Int. Cl. C22B 21/00; C22B 3/22; C22B 3/44

(52) U.S. Cl. CPC C22B 21/0015; C22B 3/22; C22B 3/44

(57) ABSTRACT

The disclosure relates to a method for recovering an iron and aluminum from a red mud, which includes the following steps: providing a red mud, a mass percentage of an alumogoethite is not less than 20% and a mass percentage of Fe₂O₃ is not less than 40% in the red mud; mixing the red mud with a circulating mother liquor and an additive and performing a wet treatment above 260° C. to obtain an ore pulp; performing a liquid-solid separation on the ore pulp after the ore pulp is flash evaporated, to obtain a separated iron material and a separated liquid; performing a seed precipitation on the separated liquid after the separated liquid is refined, or performing a seed precipitation on the separated liquid after the separated liquid is combined with an existing refined liquid; and, preforming an iron separation on the separated iron material after washed to obtain an iron concentrate. The additive includes an alkaline earth metal compound. The alkaline earth metal compound is at least one of a calcium oxide, a calcium hydroxide, a magnesium oxide and a magnesium hydroxide.

### CROSS-REFERENCE TO RELATED APPLICATIONS

This application claims the priority to Chinese patent application No. 202310045882.2 filed on Jan. 30, 2023 and entitled “Method for recovering iron and aluminum from red mud”, the entire content of which is incorporated herein by reference.

### TECHNICAL FIELD

The disclosure relates to the field of aluminum industry, and in particular to a method for recovering an iron and aluminum from a red mud.

### BACKGROUND

In recent years, bauxite resources have become increasingly scarce in China, and more and more aluminum oxide companies use imported bauxite to produce an aluminum oxide. Imports of the bauxite in China reached 107 million tons in 2021, in which the bauxite, which has characteristics of high-iron content and low-silicon content, accounts for more than half of total imported amount. In such bauxite with high-iron content and low-silicon content, SiO₂ content is less than 3%; Fe₂O₃ content is greater than 20%; and iron-containing minerals mainly exist in a form of a hematite and an alumogoethite, the alumogoethite having a relatively high content which accounts for more than 10% of a total amount of such bauxite with high-iron content and low-silicon content.

At present, such bauxite with high-iron content and low-silicon content is generally digested by a low-temperature Bayer process, generally with a digestion temperature of 105° C.˜150° C., a digestion time of 30 min˜60 min, and a concentration of caustic alkali in a circulating mother liquor of 180 g/L˜220 g/L. But a boehmite in such bauxite with high-iron content and low-silicon content is difficult to digest out, and the alumogoethite cannot be converted, resulting in an Al₂O₃ content ≥15% and a Fe₂O₃ content >40% and an alumogoethite content >20% in a discharged red mud. At the same time, there are also defects such as a high bauxite consumption per ton of aluminum oxide, a poor iron separation performance of the discharged red mud and an iron concentrate yield of less than 5%.

There is still no economically feasible industrial application technology for the above-mentioned high-iron-content red mud with high alumogoethite content. As a result, although an iron content in such red mud is much higher than that in the digested red mud from mines in China, most of such red mud is still stockpiled, thereby not only taking up land and polluting environment, but also causing a lot of waste of resources.

### SUMMARY

A technical problem of difficulty in processing a high-iron-content red mud with high alumogoethite content is solved by utilizing one or more embodiments of the disclosure.

A method for recovering an iron and aluminum from a red mud is provided by the embodiments of the disclosure, which includes: providing a red mud, in which a mass percentage of an alumogoethite is not less than 20% and a mass percentage of Fe₂O₃ is not less than 40%;

mixing the red mud with a circulating mother liquor and an additive, and performing a wet treatment above 260° C. to obtain an ore pulp; performing a liquid-solid separation on the ore pulp after the ore pulp is flash evaporated, to obtain a separated iron material and a separated liquid; performing a seed precipitation on the separated liquid after the separated liquid is refined, or performing a seed precipitation on the separated liquid after the separated liquid is combined with an existing refined liquid; and, preforming an iron separation on the separated iron material after washed to obtain an iron concentrate; The additive includes an alkaline earth metal compound. The alkaline earth metal compound is at least one of a calcium oxide, a calcium hydroxide, a magnesium oxide and a magnesium hydroxide.

### BRIEF DESCRIPTION OF DRAWINGS

The accompanying drawing, which is incorporated in and constitutes a portion of this specification, and illustrates embodiments consistent with the disclosure and serves to explain principles of the disclosure together with the description.

In order to more clearly illustrate the embodiments of the disclosure or the technical solutions in the related art, the accompanying drawings needed to be used in the description of the embodiments or the related art will be briefly introduced below. Obviously, for those skilled in the art, other accompanying drawings can also be obtained based on the accompanying drawing without creative efforts.

FIG. 1 shows a schematic flow diagram of a method for recovering an iron and aluminum from a red mud according to some embodiments of the disclosure.

### DESCRIPTION OF EMBODIMENTS

In order to make purposes, technical solutions and advantages of the embodiments of the disclosure clearer, the technical solutions in the embodiments of the disclosure will be clearly and completely described below in conjunction with the accompanying drawing according to the embodiments of the disclosure. Obviously, the described embodiments are some embodiments of the disclosure, but not all embodiments. Based on the embodiments in the disclosure, all other embodiments obtained by those skilled in the art without any creative efforts fall within the scope of protection sought for by the disclosure.

Unless otherwise specifically stated, the terms used herein are to be understood as commonly used in the art. Therefore, unless otherwise defined, all technical and scientific terms used herein have the same meaning as commonly understood by one of ordinary skill in the art to which the disclosure belongs. If there is any conflict, this specification takes precedence.

Unless otherwise specified, various raw materials, reagents, instruments, and equipment used in the disclosure are commercially available or obtained through existing methods.

Some imported bauxites have a high content of alumogoethite, and a red mud produced from the bauxites contains a large amount of alumogoethite, which is difficult to process.

The technical solutions provided by the embodiments of the disclosure solve the above technical problems. The general idea is as follows.

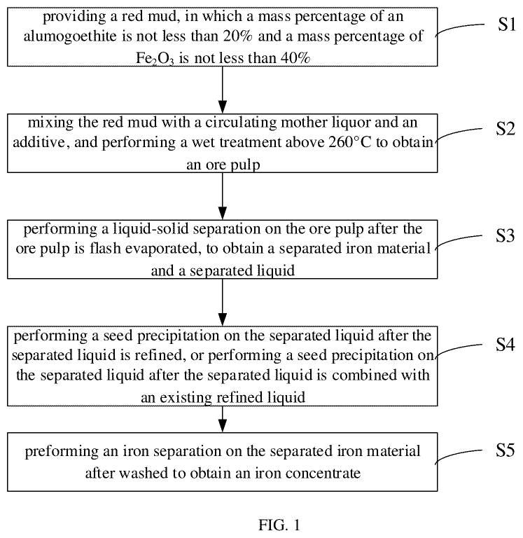

A method for recovering an iron and aluminum from a red mud is provided according to embodiments of the disclosure. Referring to FIG. 1, the method for recovering the iron and aluminum from the red mud includes:

Step S1: providing a red mud, in which a mass percentage of an alumogoethite is not less than 20% and a mass percentage of Fe₂O₃ is not less than 40%;

Step S2: mixing the red mud with a circulating mother liquor and an additive, and performing a wet treatment above 260° C. to obtain an ore pulp;

Step S3: performing a liquid-solid separation on the ore pulp after the ore pulp is flash evaporated, to obtain a separated iron material and a separated liquid;

Step S4: performing a seed precipitation on the separated liquid after the separated liquid is refined, or performing a seed precipitation on the separated liquid after the separated liquid is combined with an existing refined liquid; and,

Step S5: preforming an iron separation on the separated iron material after washed to obtain an iron concentrate.

The additive includes an alkaline earth metal compound. The alkaline earth metal compound is at least one of a calcium oxide, a calcium hydroxide, a magnesium oxide and a magnesium hydroxide.

Those skilled in the art can understand that the red mud is a solid waste residue that an aluminum oxide is produced by a Bayer process, which is a conventional method for producing the aluminum oxide.

Those skilled in the art can understand that the circulating mother liquor is a common raw material in the Bayer process for producing the aluminum oxide. The circulating mother liquor has extreme alkalinity and can digest aluminum-containing compounds in the bauxite to form a sodium aluminate solution which is the refined liquid described in step S4. After the sodium aluminate solution is processed to precipitate an aluminum hydroxide, a remaining liquid phase can be recycled for use through processes such as evaporation and concentration and so on, and can be used again to digest the aluminum-containing compounds in the bauxite, and therefore it is called the circulating mother liquor.

Those skilled in the art can understand that, the separated liquid is refined in step S4, indicates that the separated liquid is further filtered to remove fine floating matters.

Those skilled in the art can understand that the iron separation is a conventional process in the art, and generally includes a magnetic separation. In practical applications, the iron separation often also includes auxiliary processes such as a physical classification and a floating separation.

Those skilled in the art can understand that the alumogoethite is non-magnetic, and thus it is difficult to conduct the magnetic separation on the alumogoethite. After an aluminum element in the alumogoethite is transferred into a solution, remaining iron-containing compounds have increased magnetisms and thus are easily magnetically separated.

A purpose of adding the alkaline earth metal compound herein is as follows. Titanium minerals (anatase and rutile) in the bauxite react under an alkaline condition to produce a sodium titanate. The sodium titanate has a small solubility, and thus is prone to precipitate to generate a dense wrapping layer which will wrap around a surface of the alumogoethite to prevent a reaction of the alumogoethite with the alkaline solution. The additive includes at least one of a calcium oxide, a calcium hydroxide, a magnesium oxide, and a magnesium hydroxide, which can react with the titanium minerals to generate a calcium titanate or a magnesium titanate, and therefore an influence of the titanium minerals can be eliminated, a reaction of the alumogoethite can be promoted and a recovery rate of iron can be increased.

The disclosure is aimed at red mud with a mass percentage of alumogoethite of not less than 20% and a mass percentage of Fe₂O₃ of not less than 40%, the influence of titanium minerals can be eliminated by raising a temperature of wet treatment to above 260° C. and adding an additive containing alkaline earth metal compounds. On the one hand, the aluminum element in the alumogoethite can be transferred to a solution for recovery; on the other hand, the alumogoethite can be converted into magnetic substances that are easily magnetically separated, so as to facilitate a recovery of iron elements through the magnetic separation. Therefore, the red mud can be processed and recycled according to some embodiments of the disclosure.

In some embodiments of the disclosure, a concentration of a sodium oxide in the circulating mother liquor is not less than 180 g/L.

Those skilled in the art can understand that in the circulating mother liquor, a sodium usually exists in an ionic form, but in industrial production, a concentration of a sodium hydroxide is often converted into the concentration of the sodium oxide for measuring, and thus the concentration of sodium hydroxide and the concentration of the sodium oxide can be converted to each other. As an example, the concentration of the sodium hydroxide, which is converted from the concentration of the sodium oxide of 180 g/L in the disclosure, is: 180−62×80 g/L=232 g/L.

An advantageous effect of the concentration of the sodium oxide in the circulating mother liquor being not less than 180 g/L is that when the concentration of the sodium oxide is less than 180 g/L, a conversion of the alumogoethite is incomplete, which affects a recovery of an iron and aluminum in the red mud.

In some embodiments of the disclosure, a molecular ratio of a sodium oxide to an aluminum oxide in the circulating mother liquor is 2.0 to 4.0.

Those skilled in the art can understand that the molecular ratio of the sodium oxide to the aluminum oxide is a common saying in this field. In fact, a value of the molecular ratio of the sodium oxide to the aluminum oxide is equal to a molar ratio of sodium atoms to aluminum atoms in a solution. However, in a production process, it is more convenient to measure the molecular ratio in terms of oxides.

An advantageous effect of the molecular ratio of the sodium oxide to the aluminum oxide in the circulating mother liquor being 2.0˜4.0 is that when the molecular ratio of the sodium oxide to the aluminum oxide in the circulating mother liquor is lower than 2.0, a concentration of the aluminum oxide in the circulating mother liquor is higher, such that a digestion power of the aluminum oxide is lower, which is not conducive to a recovery of the aluminum oxide; when the molecular ratio of the sodium oxide to the aluminum oxide in the circulating mother liquor is higher than 4.0, an amount of the red mud is larger and a content of solid is higher, which is not conducive to a subsequent liquid-solid separation.

In some embodiments of the disclosure, in the mixing the red mud with the circulating mother liquor and additive, the molecular ratio of the sodium oxide to the aluminum oxide in a separated liquid obtained by the liquid-solid separation is controlled to be not less than 1.30 by controlling a ratio of the red mud to the circulating mother liquor to which the red mud belongs.

An advantageous effect of the molecular ratio of the sodium oxide to the aluminum oxide in the separated liquid being no less than 1.30 is that when the molecular ratio is higher than 1.30,the separated liquid is less likely to be hydrolyzed, causing an aluminum oxide loss during the subsequent liquid-solid separation.

In some embodiments of the disclosure, in the mixing of the red mud with the circulating mother liquor and additive, an additive amount of the alkaline earth metal compound is 3% to 8% of a dry weight of the red mud in terms of weight percentage.

In some embodiments of the disclosure, in the mixing of the red mud with the circulating mother liquor and additive, an additive amount of the alkaline earth metal compound is 3% to 7% of a dry weight of the red mud in terms of weight percentage.

In some embodiments of the disclosure, the additive further includes an oxidant.

In some embodiments of the disclosure, the oxidant is at least one of a hydrogen peroxide and a hypochlorous acid.

An advantageous effect of adding the oxidant is to oxidize macromolecular organic matters in an aluminum oxide production system into small molecular organic matters or a carbonate, thereby preventing an increase in a solution viscosity caused by excessive organic matters in the system.

In some embodiments of the disclosure, in the mixing of the red mud with the circulating mother liquor and additive, an additive amount of the oxidant is 0.2% to 0.4% of a dry weight of the red mud in terms of weight percentage.

In some embodiments of the disclosure, a time of the wet treatment is not less than 60 minutes.

In some embodiments of the disclosure, a manner of the liquid-solid separation is filtration.

The disclosure will be further described below with reference to examples. It should be understood that these examples are only used to illustrate the disclosure and are not intended to limit a scope sought for by the disclosure. Experimental methods without specifying specific conditions in the following examples are typically performed in accordance with national standards in China. If there is no corresponding national standards in China, general international standards, conventional conditions, or conditions recommended by the manufacturer shall be followed.

### EXAMPLE 1

This embodiment provides a method for recovering iron and aluminum from a red mud.

First, a red mud is provided. A chemical composition of the red mud is: contents by mass percentage of Fe₂O₃, Al₂O₃ and SiO₂ are 54.65%, 18.76% and 4.50%, respectively. A phase composition is that contents of an alumogoethite, a hematite, boehmite and gibbsite are 38%, 25%, 12% and 2%, respectively.

The high-iron-content red mud is directly subjected to an iron separation, and a yield of an iron concentrate with a TFe content greater than 56% is <5%; the red mud is subjected to a test of the iron separation after high-temperature reduction magnetization roasting, and the yield of the iron concentrate with the TFe content greater than 56% is about 20%.

Subsequently, the above red mud is processed as follows:

Sa: mixing the red mud with a circulating mother liquor and an additive, and performing a wet treatment to obtain an ore pulp;

Sb: performing a liquid-solid separation on the ore pulp after the ore pulp is flash evaporated, to obtain a separated iron material and a separated liquid;

Sc: performing a seed precipitation on the separated liquid after the separated liquid is refined, or performing a seed precipitation on the separated liquid after the separated liquid is combined with an existing refined liquid; and,

Sd: preforming an iron separation on the separated iron material after washed to obtain an iron concentrate.

In the above steps Sa to Sd, a temperature of the wet treatment is controlled as 260° C., the time of the wet treatment is controlled as 90 minutes, and a concentration of a sodium oxide in the circulating mother liquor is controlled to be 180 g/L. The additive includes a calcium oxide and a hydrogen peroxide. An additive amount of the calcium oxide is 5% of the dry weight of the red mud in terms of weight percentage, and an additive amount of the hydrogen peroxide is 0.4% of the dry weight of the red mud in terms of weight percentage. After the wet treatment, a molecular ratio of the sodium oxide to an aluminum oxide in the separated liquid is 1.30. A content of the Al₂O₃ in the separated iron material is reduced to 7%. A recovery rate for the aluminum oxide is 68%. The separated iron material is gradiently magnetically separated to obtain the iron concentrate with TFe content ≥56% and with a yield of 42%.

### EXAMPLE 2

This embodiment provides a method for recovering iron and aluminum from a red mud,

First, the same red mud as in Example 1 is provided;

Subsequently, the above red mud is processed as follows:

Sa: Mixing the red mud with a circulating mother liquor and an additive, and performing a wet treatment to obtain an ore pulp;

Sb: performing a liquid-solid separation on the ore pulp after the ore pulp is flash evaporated, to obtain a separated iron material and a separated liquid;

Sc: performing a seed precipitation on the separated liquid after the separated liquid is refined, or performing a seed precipitation on the separated liquid after the separated liquid is combined with an existing refined liquid; and,

Sd: preforming an iron separation on the separated iron material after washed to obtain an iron concentrate;

In the above steps Sa to Sd, a temperature of the wet treatment is controlled as 265° C., the time of the wet treatment is controlled as 60 minutes, and a concentration of a sodium oxide in the circulating mother liquor is controlled to be 200 g/L. The additive includes a calcium oxide and a hydrogen peroxide. An additive amount of the calcium oxide is 3% of the dry weight of the red mud in terms of weight percentage, and an additive amount of the hydrogen peroxide is 0.4% of the dry weight of the red mud in terms of weight percentage. After the wet treatment, a molecular ratio of the sodium oxide to an aluminum oxide in the separated liquid is 1.42. A content of the Al₂O₃ in the separated iron material is reduced to 6.7%. A recovery rate for the aluminum oxide is 70%. The separated iron material is gradiently magnetically separated to obtain the iron concentrate with TFe content ≥56% and with a yield of 45%.

### EXAMPLE 3

This embodiment provides a method for recovering iron and aluminum from a red mud,

First, the same red mud as in Example 1 is provided;

Subsequently, the above red mud is processed as follows:

Sa: Mixing the red mud with a circulating mother liquor and an additive, and performing a wet treatment to obtain an ore pulp;

Sb: performing a liquid-solid separation on the ore pulp after the ore pulp is flash evaporated, to obtain a separated iron material and a separated liquid;

Sc: performing a seed precipitation on the separated liquid after the separated liquid is refined, or performing a seed precipitation on the separated liquid after the separated liquid is combined with an existing refined liquid; and,

Sd: preforming an iron separation on the separated iron material after washed to obtain an iron concentrate;

In the above steps Sa to Sd, a temperature of the wet treatment is controlled as 270° C., the time of the wet treatment is controlled as 60 minutes, and a concentration of a sodium oxide in the circulating mother liquor is controlled to be 220 g/L. The additive includes a calcium oxide and a hydrogen peroxide. An additive amount of the calcium oxide is 4% of the dry weight of the red mud in terms of weight percentage, and an additive amount of the hydrogen peroxide is 0.4% of the dry weight of the red mud in terms of weight percentage. After the wet treatment, a molecular ratio of the sodium oxide to an aluminum oxide in the separated liquid is 1.42. A content of the Al₂O₃ in the separated iron material is reduced to 6.2%. A recovery rate for the aluminum oxide is 73%. The separated iron material is gradiently magnetically separated to obtain the iron concentrate with TFe content ≥56% and with a yield of 47%.

### EXAMPLE 4

This embodiment provides a method for recovering iron and aluminum from a red mud,

First, a red mud is provided. A chemical composition of the red mud is: contents by mass percentage of Fe₂O₃, Al₂O₃ and SiO₂ are 61.28%, 13.7% and 4.24%, respectively. A phase composition is that contents of an alumogoethite, a hematite, and boehmite are 36%, 33% and 8%, respectively.

The high-iron-content red mud is directly subjected to an iron separation, and a yield of an iron concentrate with a TFe content greater than 56% is <5%; the red mud is subjected to a test of the iron separation after high-temperature reduction magnetization roasting, and the yield of the iron concentrate with the TFe content greater than 56% is about 25%.

Subsequently, the above red mud is processed as follows:

Sa: Mixing the red mud with a circulating mother liquor and an additive, and performing a wet treatment to obtain an ore pulp;

Sb: performing a liquid-solid separation on the ore pulp after the ore pulp is flash evaporated, to obtain a separated iron material and a separated liquid;

Sc: performing a seed precipitation on the separated liquid after the separated liquid is refined, or performing a seed precipitation on the separated liquid after the separated liquid is combined with an existing refined liquid; and,

Sd: preforming an iron separation on the separated iron material after washed to obtain an iron concentrate;

In the above steps Sa to Sd, a temperature of the wet treatment is controlled as 260° C., the time of the wet treatment is controlled as 90 minutes, and a concentration of a sodium oxide in the circulating mother liquor is controlled to be 180 g/L. The additive includes a calcium oxide and a hydrogen peroxide. An additive amount of the calcium oxide is 6% of the dry weight of the red mud in terms of weight percentage, and an additive amount of the hydrogen peroxide is 0.2% of the dry weight of the red mud in terms of weight percentage. After the wet treatment, a molecular ratio of the sodium oxide to an aluminum oxide in the separated liquid is 1.42. A content of the Al₂O₃ in the separated iron material is reduced to 6.9%. A recovery rate for the aluminum oxide is 65%. The separated iron material is gradiently magnetically separated to obtain the iron concentrate with TFe content >56% and with a yield of 40%.

### EXAMPLE 5

This embodiment provides a method for recovering iron and aluminum from a red mud,

First, the same red mud as in Example 4 is provided;

Subsequently, the above red mud is processed as follows:

Sa: Mixing the red mud with a circulating mother liquor and an additive, and performing a wet treatment to obtain an ore pulp;

Sb: performing a liquid-solid separation on the ore pulp after the ore pulp is flash evaporated, to obtain a separated iron material and a separated liquid;

Sc: performing a seed precipitation on the separated liquid after the separated liquid is refined, or performing a seed precipitation on the separated liquid after the separated liquid is combined with an existing refined liquid; and,

Sd: preforming an iron separation on the separated iron material after washed to obtain an iron concentrate;

In the above steps Sa to Sd, a temperature of the wet treatment is controlled as 265° C., the time of the wet treatment is controlled as 70 minutes, and a concentration of a sodium oxide in the circulating mother liquor is controlled to be 200 g/L. The additive includes a calcium oxide and a hydrogen peroxide. An additive amount of the calcium oxide is 5% of the dry weight of the red mud in terms of weight percentage, and an additive amount of the hydrogen peroxide is 0.2% of the dry weight of the red mud in terms of weight percentage. After the wet treatment, a molecular ratio of the sodium oxide to an aluminum oxide in the separated liquid is 1.42. A content of the Al₂O₃ in the separated iron material is reduced to 6.5%. A recovery rate for the aluminum oxide is 70%. The separated iron material is gradiently magnetically separated to obtain the iron concentrate with TFe content ≥56% and with a yield of 43%.

### EXAMPLE 6

This embodiment provides a method for recovering iron and aluminum from a red mud,

First, the same red mud as in Example 4 is provided;

Subsequently, the above red mud is processed as follows:

Sa: Mixing the red mud with a circulating mother liquor and an additive, and performing a wet treatment to obtain an ore pulp;

Sb: performing a liquid-solid separation on the ore pulp after the ore pulp is flash evaporated, to obtain a separated iron material and a separated liquid;

Sc: performing a seed precipitation on the separated liquid after the separated liquid is refined, or performing a seed precipitation on the separated liquid after the separated liquid is combined with an existing refined liquid; and,

Sd: preforming an iron separation on the separated iron material after washed to obtain an iron concentrate;

In the above steps Sa to Sd, a temperature of the wet treatment is controlled as 275° C., the time of the wet treatment is controlled as 60 minutes, and a concentration of a sodium oxide in the circulating mother liquor is controlled to be 220 g/L. The additive includes a calcium oxide and a hydrogen peroxide. An additive amount of the calcium oxide is 3% of the dry weight of the red mud in terms of weight percentage, and an additive amount of the hydrogen peroxide is 0.2% of the dry weight of the red mud in terms of weight percentage. After the wet treatment, a molecular ratio of the sodium oxide to an aluminum oxide in the separated liquid is 1.42. A content of the Al₂O₃ in the separated iron material is reduced to 5.9%. A recovery rate for the aluminum oxide is 75%. The separated iron material is gradiently magnetically separated to obtain the iron concentrate with TFe content ≥56% and with a yield of 46%.

The above technical solutions provided by the embodiments of the disclosure, compared with existing technology, have the following advantages:

A method for recovering an iron and aluminum from a red mud is provided according to some embodiments of the disclosure. For the red mud with a mass percentage of an alumogoethite of not less than 20% and a mass percentage of Fe203 of not less than 40%, the influence of titanium minerals can be eliminated by raising a temperature of wet treatment to above 260° C. and adding an additive containing alkaline earth metal compounds. On the one hand, the aluminum element in the alumogoethite can be transferred to a solution for recovery; on the other hand, the alumogoethite can be converted into magnetic substances that are convenient for a magnetic separation, so as to facilitate a recovery of iron elements through the magnetic separation. Therefore, the red mud can be processed and recycled according to some embodiments of the disclosure.

Various embodiments of the present disclosure may exist in the form of a range; it should be understood that the description in the form of a range is only for convenience and simplicity and should not be understood as a hard limit to the scope of the present disclosure; therefore, the described range should be considered to have specifically disclosed all possible subranges as well as the single values within such a range. For example, a description of a range from 1 to 6 should be considered to have disclosed subranges, such as from 1 to 3, from 1 to 4, from 1 to 5, from 2 to 4, from 2 to 6, and from 3 to 6, and a single number within the stated range, such as 1, 2, 3, 4, 5, and 6, which applies regardless of the range. Additionally, whenever a numerical range is indicated herein, it is intended to include any cited number (fractional or whole) within the indicated range.

In the disclosure, unless otherwise specified, the directional words used such as “upper” and “lower” refer specifically to the direction of the figure in the drawing. In addition, in the description of the present disclosure, the terms “including”, “comprising” and the like refer to “including but not limited to”. Furthermore, the terms “include”, “comprise” or any other variations thereof are intended to cover a non-exclusive inclusion such that a process, method, article, or apparatus that includes a list of elements includes not only those elements, but also those not expressly listed other elements, or elements inherent to the process, method, article or apparatus. Without further limitation, an element defined by the statement “comprising . . . ” does not exclude the presence of additional identical elements in a process, method, article, or device that includes the stated element. In the disclosure, relational terms such as “first” and “second” are merely used to distinguish one entity or operation from another and do not necessarily require or imply any such actual relationship or sequence between these entities or operations. In the disclosure, “and/or” describes the relationship between associated objects, indicating that there may be three relationships. For example, A and/or B may refer to: A alone, both A and B, and B alone. For the association relationship of more than three associated objects described with “and/or”, it represents that any one of the three associated objects can exist alone, or at least two of them can exist at the same time. For example, for A, and/or B, and/or C can represent that any one of A, B, and C exists alone, or any two of them exist at the same time, or three of them exist at the same time. In the disclosure, “at least one” refers to one or more, and “plurality” refers to two or more. “At least one”, “at least one of the following” or similar expressions thereof refers to any combination of these items, including single items or any combination of plural items. For example, “at least one of a, b, or c”, or “at least one of a, b, and c” may represent: a, b, c, a˜b (that is, a and b), a˜c, b˜c, or a˜b˜c in which a, b, and c can each be single or multiple.

The above descriptions are only embodiments of the disclosure, enabling those skilled in the art to understand or implement the disclosure. Various modifications to these embodiments will be readily apparent to those skilled in the art, and the generic principle defined in the disclosure may be practiced in other embodiments without departing from the spirit or scope of the disclosure. Therefore, the disclosure is not to be limited to the embodiments shown in the disclosure but is to be accorded the widest scope consistent with the principles and novel features claimed in the disclosure.

What is claimed is:

1. A method for recovering an iron and aluminum from a red mud, comprising:
providing a red mud, in which a mass percentage of an alumogoethite is not less than 20% and a mass percentage of Fe₂O₃ is not less than 40%;
mixing the red mud with a circulating mother liquor and an additive, and performing a wet treatment above 260° C. to obtain an ore pulp;
performing a liquid-solid separation on the ore pulp after the ore pulp is flash evaporated, to obtain a separated iron material and a separated liquid;
performing a seed precipitation on the separated liquid after the separated liquid is refined, or performing a seed precipitation on the separated liquid after the separated liquid is combined with an existing refined liquid; and,
preforming an iron separation on the separated iron material after washed to obtain an iron concentrate;
wherein, the additive comprises an alkaline-earth metal compound, and the alkaline-earth metal compound is at least one of a calcium oxide, a calcium hydroxide, a magnesium oxide and a magnesium hydroxide.

2. The method for recovering the iron and aluminum from the red mud according to claim 1, wherein a concentration of a sodium hydroxide in the circulating mother liquor is not less than 180 g/L.

3. The method for recovering the iron and aluminum from the red mud according to claim 2, wherein a molecular ratio of a sodium oxide to an aluminum oxide in the circulating mother liquor is 2.0 to 4.0.

4. The method for recovering the iron and aluminum from the red mud according to claim 3, wherein in the mixing the red mud with the circulating mother liquor and additive, a molecular ratio of a sodium oxide to an aluminum oxide in the separated liquid obtained by the liquid-solid separation is controlled to be not less than 1.30 by controlling a ratio of the red mud to the circulating mother liquor to which the red mud belongs.

5. The method for recovering the iron and aluminum from the red mud according to claim 1, wherein in the mixing of the red mud with the circulating mother liquor and additive, an additive amount of the alkaline-earth metal compound is 3% to 8% of a dry weight of the red mud in terms of weight percentage.
